(19) United States
(12) Patent Application Publication
(10) Pub. No.: US 2012/0234907 A1
(43) Pub. Date: Sep. 20, 2012

(54) System and process for managing hosting and redirecting the data output of a 2-D QR barcode

(76) Inventors: Donald Jordan Clark, Mobile, AL (US); William P. Kahalley, Mobile, AL (US)

(21) Appl. No.: 13/300,958

(22) Filed: Nov. 21, 2011

Related U.S. Application Data
(60) Provisional application No. 61/454,431, filed on Mar. 18, 2011.

(51) Int. Cl. G06F 17/30

(52) U.S. Cl. 235/375

(57) ABSTRACT

A reusable QR code system is disclosed having a web host for receiving a scan of the QR code over a first link from a user device and redirecting the scan to a different website based on subscriber data entered into the web host by a system subscriber. A second link contained in subscriber data redirects the user device to a second website to access full property information. A subscriber input on the server interface allows the subscriber to change the second link to a new link so that the same QR code may be reused to retrieve different subscriber property information each time the full information becomes obsolete.

### BACKGROUND OF THE INVENTION

The invention is a system and method for managing and changing the redirection link of a 2-D QR code barcode stored on a web host wherein a subscriber to the web host can change the link enabling reuse of the code to link to different websites.

A QR code (quick response code) is a specific matrix barcode (two-dimensional code), readable by dedicated QR barcode readers and camera phones. Data encoded in the code can be text, URL, or other data. QR codes storing addresses and Uniform Resource Locators (URLs) may appear in magazines, on signs, buses, business cards, or almost any object about which users might need information. Users with a camera phone equipped with the correct reader application can scan the image of the QR code to display text, contact information, connect to a wireless network, or open a web page in the phone's browser. For example, a QR code may be used for business to link a website on the front of a business card to more easily provide additional information and converting leads, or a QR bar code may be on a real estate sign upon property for sale to allow people with smart phones, such as iPhones, Androids, Blackberry's and others, to quickly scan the QR code using a free QR Reader and be taken to a website with content and more information about the property or object. However, after the property is sold, the sign is usually disposed of.

### SUMMARY OF THE INVENTION

The above objectives are accomplished according to the present invention by providing a system which allows a single QR code to be recycled over and over again providing links to different websites. A real estate agent, for example, can buy one sign with a large QR barcode attached, and reuse it for different homes every time one sells saving the cost of a new sign for each home. In an exemplary embodiment, a reusable QR code system is provided for hosting and redirecting subscriber data associated with a specific QR code in response to a user scanning the QR code with a scanning device. The system includes a host web server accessible by a subscriber; and a database having subscriber data stored in computer readable code accessible by the server. At least one QR code is assigned to the subscriber encoded with a first link to the web host. The subscriber data includes a second link which redirects the user to a second website where the subscriber's detailed property information can be accessed and displayed on the user's device. A computer program is stored in computer readable memory having instructions embodied in computer readable code accessible by the server for executing the instructions. The instructions include instructions for receiving and storing subscriber data assigned to a specific QR code, for receiving a scan of the QR code from a user device, and for redirecting the user to the second website where subscriber's full property information is accessed. The computer program includes instructions for allowing the subscriber to reuse the same QR code of subscriber by changing the second link on the server to access a different website and property information.

### DESCRIPTION OF THE DRAWINGS

The construction designed to carry out the invention will hereinafter be described, together with other features thereof.

The invention will be more readily understood from a reading of the following specification and by reference to the accompanying drawings

FIG. 1 is a perspective view illustrating use of the invention as applied to furnishing detailed property information when selling real estate according to the invention;

FIG. 2 is a schematic illustration of a basic system for accessing information using QR codes through a web host having an interface where a subscriber may change the web address encoded in the QR code for reuse with a different property or object.

FIG. 2A is a schematic illustration of a normal operation of a system wherein a user of the subscriber scans a QR code of the subscriber and automatically receives the property information for display on the users scanning device;

FIG. 3 is a schematic diagram and flowchart illustrating the scheme of a QR code system for creating an encoded QR code by a subscriber for to be scanned at a property (home) or other object by a user of the system;

FIG. 4 is a flowchart of a system according to the invention which allows the subscriber to change the redirect link and reuse a QR code at another property after the first property is sold and the property information is obsolete; and

FIG. 5 is a schematic illustration of a system interface allowing the subscriber to reuse a code by changing the link of the code.

### DESCRIPTION OF A PREFERRED EMBODIMENT

The present invention will now be described more fully with reference to the drawings in which a preferred embodiment of the invention is shown. This invention may, however, be embodied in many different forms and should not be construed as limited to the embodiment set forth herein. Rather, the embodiment is provided so that this disclosure will be thorough and complete and will fully convey the scope of the invention to those skilled in the art. The detailed description that follows may be presented in terms of steps of methods or in program procedures executed on a computer or network of computers. These procedural descriptions are representations used by those skilled in the art to most effectively convey the substance of their work to others skilled in the art. The procedures herein described are generally a self-consistent sequence of steps leading to a desired result. These steps require physical manipulations of physical quantities such as electrical or optical signals capable of being stored, transferred, combined, compared, or otherwise manipulated. A computer readable medium can be included that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described with reference to flowchart illustrations of methods, apparatus (“systems”), or computer program products according to the invention. It will be understood that each block of a flowchart illustration may be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks. These computer readable instructions may also be stored in a computer readable medium that can direct a computer or other programmable data processing apparatus to function in a particular manner, such that the instructions stored in a computer readable medium that implement the functions specified in the flowchart block or blocks. Computer program instructions may also be loaded onto a computer or other programmable apparatus to produce a computer executed process such that the instructions are executed on the computer or other programmable apparatus to provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

In the context of this invention the server may be a computer program running to serve the requests of other programs, the “subscribers”. The server performs some computational task or executes instructions on behalf of subscribers on the same computer or one connected through the network. Web server software or a computer program is run on the server to accomplish the needs of the subscriber's customers or users over the web. The term “link” refers an internet link (URL, URI, etc.) directing a user device to a designated web site.

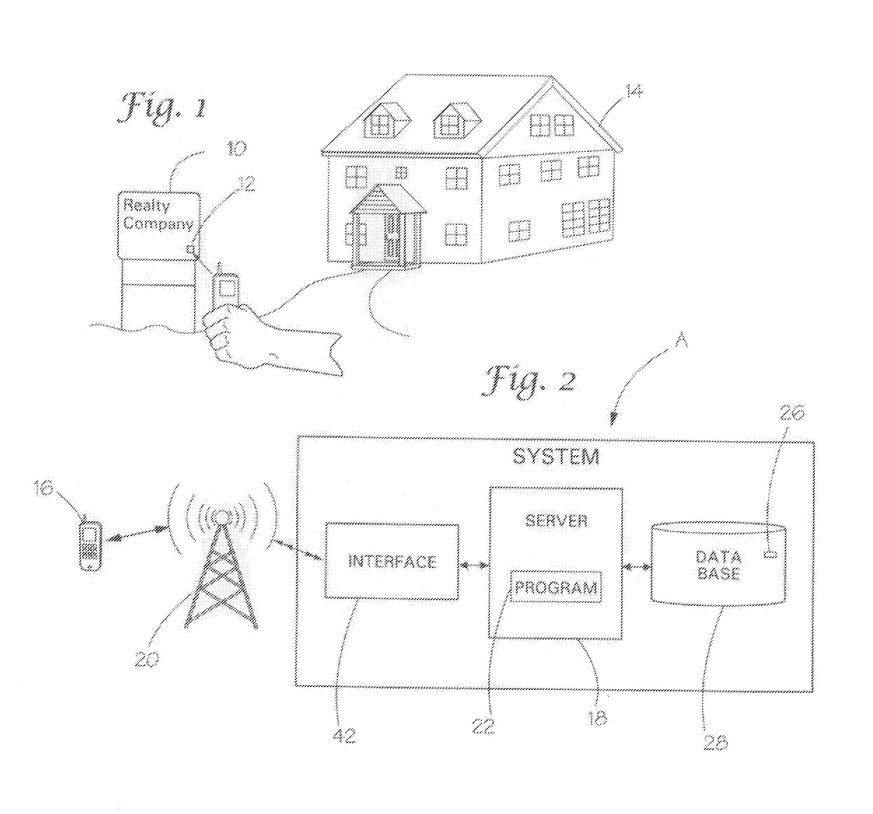

Referring to the drawings, the invention will now be described in more detail. While the invention has application to many QR code uses, the use on a realtor's sign will be described as a particularly advantageous embodiment, it being understood that the code may be attached to any object to obtain additional detailed information about the object. FIG. 1 illustrates an embodiment of the invention as applied to sale of real estate property. A system and method A is illustrated where a 2-D QR code barcode (“QR code”) 12 is placed on a real estate for sale sign 10 on a property 14. By using a smartphone 16 or the like user scanning device, the QR code is scanned which links the smartphone to a web host having a server 18 via a cellular link 20 whereupon the scan is redirected to full, detailed property information. The server runs a host program 22 or software that operates the server to meet the needs of a subscriber (reactor) and the subscriber's users (house buyers).

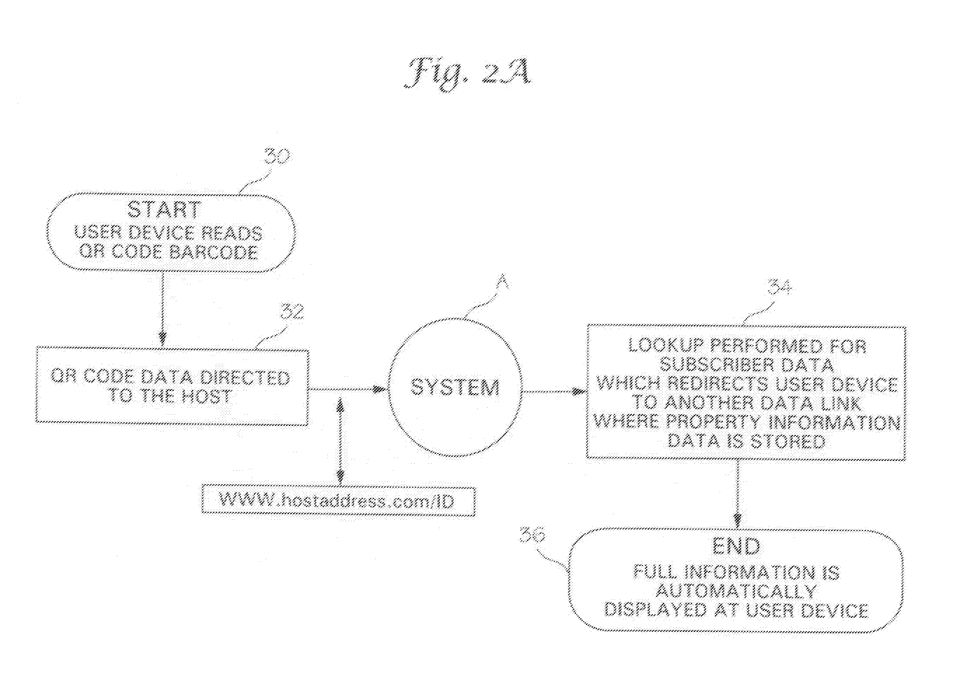

As can best be seen in FIG. 2, an interface 42 on a webpage or server computer gives the subscriber the capability to see all QR codes 24 they manage and would also give them the capability to input and save subscriber data 26 containing an information link to the detailed property information assigned to the QR code scanned. The data is saved in a system data base 28. The server interface allows subscriber to enter new subscriber data for each QR code as many times as they like.

Referring now to FIG. 2A, a flow chart of the basic operation of the invention will be described. The process starts with a QR code being scanned by a user device at 30. At 32, the QR code data is directed to the host system A. At 34, the server performs a lookup for the subscriber data 26, and redirects the user device to a property redirection link (website) where the full property information data is stored. At 36, the full information from the link is automatically displayed at the user device via the web browser.

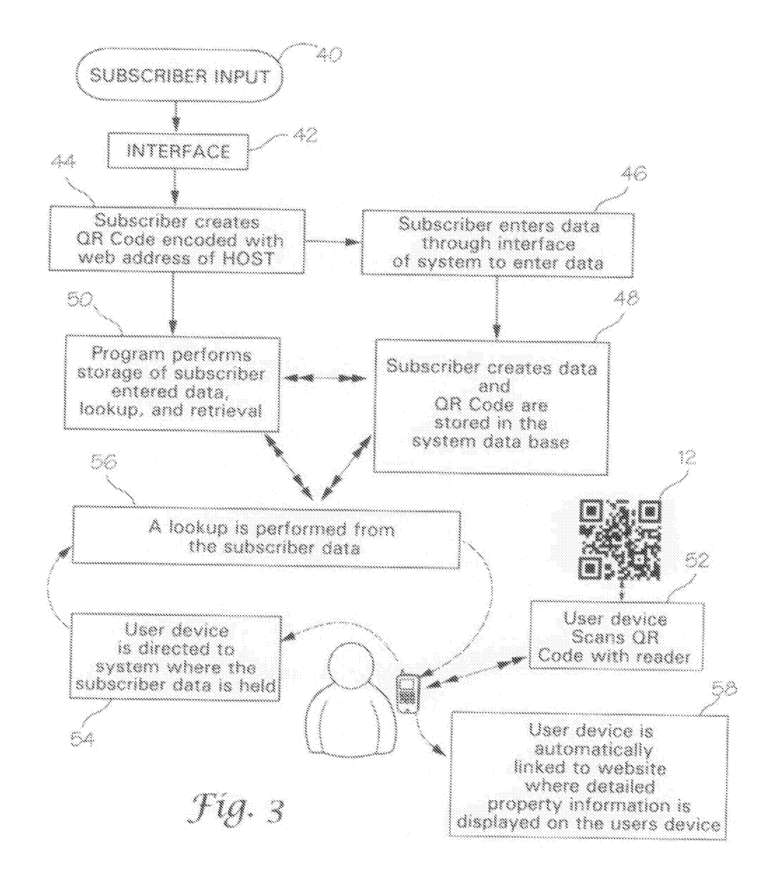

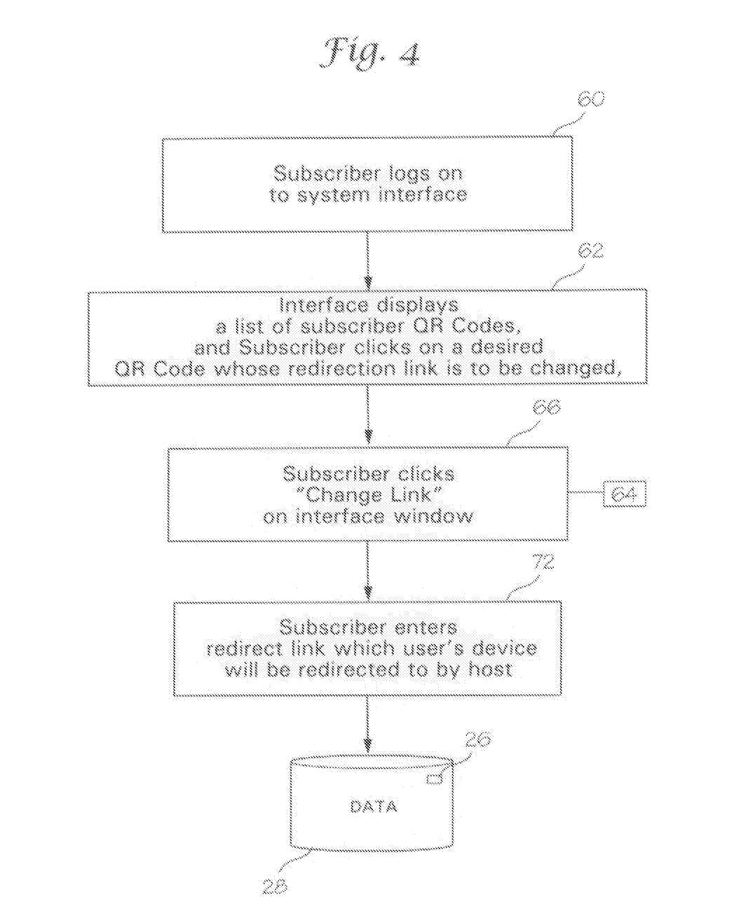

As can best be seen in FIG. 3, a system is illustrated that comprises a database 28 and utilizes server computer 18 and computer program 22 written in programming language that would handle the flow process illustrated in FIG. 2A, FIG. 3, and FIG. 4 for automatically redirecting the user to another website where the property information is stored and automatically displayed on the user device.

FIG. 3 illustrates more detail of the system and method according to the invention wherein the subscriber logs onto the system to create QR codes and inputs subscriber data at 40 of interface 42. The subscriber created QR code is encoded with the web address of the host at 44 and contains the subscriber ID. The subscriber creates a QR code using any method available, or the host of the system creates the QR code barcode on behalf of the subscriber. At 46, the subscriber enters data through the interface that will return property information to the user's scanning device when the QR code is scanned. At 48, the subscriber data 26 and QR code are stored in the system data base for future retrieval. The subscribed data includes the redirection link and the ID of each QR code of the subscriber. At 50, the system software 22 performs storage of the subscriber data, and any future lookup and retrieval of the subscriber data 26 in response to the QR code being scanned.

FIG. 3 also shows the operation of the system and process when a QR code is scanned by a user of the subscriber. At 52, the subscriber device scans the QR code with a reader. At 54, the scanned information is directed to the web server which retrieves the subscriber data and redirects the scan to the website where the property information is automatically displayed for reading at the user's scanning device.

This system could be comprised of many different types of computer systems and be created with any number of computer programming languages. These languages include, but are not limited to, HTML, Flash, Java Script, Java, C, C++, C#, Objective-C, PHP, CGI, Python, and Ruby on Rails. Having been taught the aspects, processes, and functions of the invention, the writing of a program to carry out the specified processes and functions of the system and method will be well within the purview of one having average skill in the field of programming.

The encoded QR code provides a path or link to host as shown in Figure A. When a user device scans or reads the QR code, it is directed to the system where the lookup occurs and the scan is redirected via the property information link stored in the subscriber database.

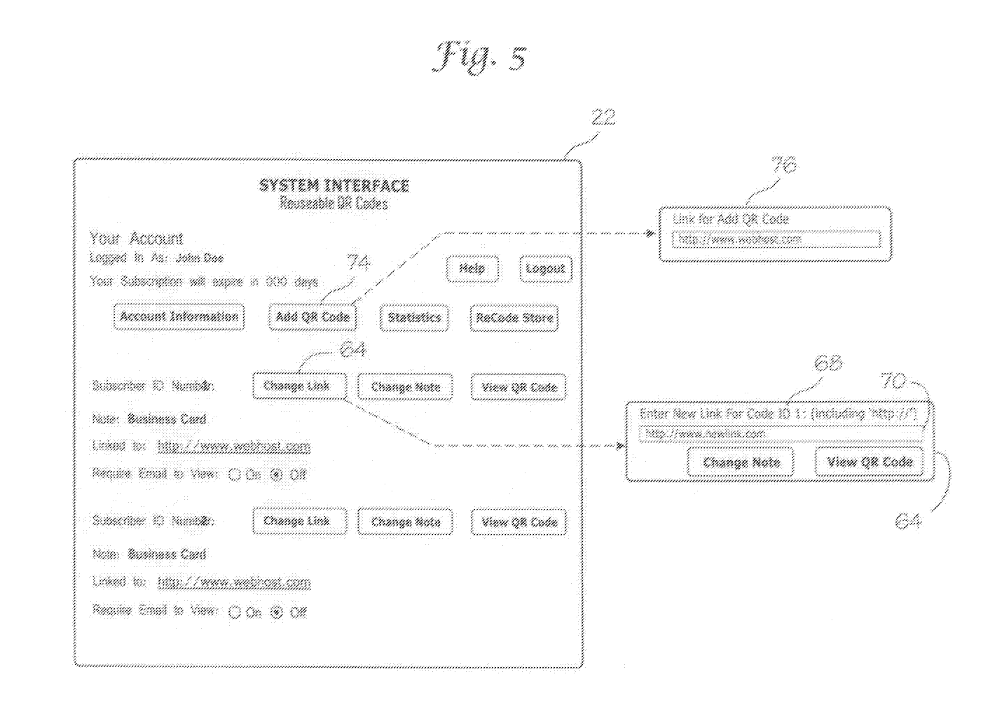

Referring to FIG. 4, the system and process for reusing a QR code according to the invention is illustrated, wherein a single QR code can be recycled to provide a link to different web sites so a realtor's sign can be used at different properties each time a property is sold and the property information is obsolete. At 60, the subscriber logs onto the system interface. Next a list of the subscriber QR codes is displayed on the interface and the subscriber can click on the QR code whose redirect link is to be changed. To do this, the subscriber clicks the “change” link window 64 on system interface 42 (FIG. 5). This opens a window 68 wherein the new link to which the user is to be directed can be entered at 70. The QR code with the redirected link is then stored in data base 28. System interface 42 also provides for the addition of new QR codes by the subscriber by clicking on the add QR code input at 74 which brings up a window at 76, whereupon the subscriber data for the new redirect link is entered.

While a preferred embodiment of the invention has been described using specific terms, such description is for illustrative purposes only, and it is to be understood that changes and variations may be made without departing from the spirit or scope of the following claims.

What is claimed is:

1. A reusable QR code system for hosting and redirecting subscriber data associated with a specific QR code in response to a user scanning the QR code with a scanning device comprising:
a host web server accessible by a subscriber;
a database having subscriber data stored in computer readable code accessible by said server;
at least one QR code belonging to the subscriber encoded with a first link directed to said web host;
said subscriber data including a second link which redirects the user to a second link where the subscriber's detailed property information can be accessed from a second website and displayed on the user's device;
a computer program stored in computer readable memory having instructions embodied in computer readable code accessible by said server for executing said instructions;
said instructions including instructions for receiving and storing subscriber data assigned to a specific QR code, instructions for receiving a scan of said QR code from a user device, and redirecting the user to said second website where subscriber's full property information is accessed;
said computer program including reuse instructions for allowing said subscriber to reuse the same QR code of subscriber by changing the second link to access a different website and property information;
whereby a single QR code can be recycled to provide a link to different websites and reused for different properties each time a property is sold.

2. A reusable QR code system having a web host for receiving a scan of said QR code from a user device and redirecting the scan to a different website based on subscriber data entered into the web host by a system subscriber, said system comprising:
a web host having a server, a server interface, and a server database;
one or more subscriber QR codes stored in said database encoded with a first link to said web host;
second link stored in subscriber data which redirects the user device to a second website to retrieve full property information; and
a subscriber input on said server interface allowing said subscriber to change said second link to a new link so that the QR code may be reused to retrieve different subscriber property information from the new link;
whereby a single QR code can be recycled to provide a link to different websites and reused for different properties each time a property is sold.

3. The system of claim 2 including a computer program stored in computer readable code having instructions executable by said server, said instructions including:
instructions for creating QR codes as subscribed to by the subscriber;
instructions for receiving the subscriber data entered by the subscriber and storing the data in said database;
instructions for adding a new QR codes in response to the subscriber inputting a subscriber request to add a QR code to his account;
instructions for changing the second link so that new subscriber property information is retrieved and displayed on the user device using the same QR code; and
program means for retrieving full information from the linked website and delivering it to the user's device for display in response to the device scanning the QR code.

4. A method whereby a single QR code on a real estate sign can be recycled to provide a link to different websites and reused for different properties each time a property is sold comprising:
providing a web host where one of the host or a subscriber to the host can create a QR code on the web host which include a link to the web host when the QR code is scanned by a subscriber's user;
scanning said QR code back to the host server upon the QR code being scanned by a user device;
redirecting the web host link to a different link entered by the subscriber and stored in a data base accessible by the web host;
performing a lookup in the database and returning said different link the subscriber has entered; and
presenting a web host interface to the subscriber that lists one or more QR codes of the subscriber and provides an input field to change the different link the QR code will redirect to so that the QR code can be changed and reused for different properties each time a property is sold so that a single QR code can be reused to provide a link to different websites and different property each time a property is sold.

5. A method of reusing a single QR code assigned to a subscriber multiple times with different subscriber data so that the QR code can be reused in multiple applications comprising:
providing a web host having a server; a server interface, a computer program written in computer readable code accessible by said server, and a data base, wherein said program includes instructions executable by said server for performing the steps of:
creating at least one QR code belonging to a subscriber, said QR code including a link back to said web host when scanned by a user scanning device;
receiving subscriber data entered by the subscriber though said interface and storing the data in said database, said subscriber data including a second link to an information web site where full information sought by the user is accessed and can be displayed on the user device; and
changing the second link after the information at the information website is no longer needed so that different property information can be accessed at a different information website;

6. The method of claim 5 including instructions for adding a new QR code in response to subscriber input through said interface requesting a QR code be added to his account.
